(19) United States
(12) Patent Application Publication
(10) Pub. No.: US 2013/0016860 A1
(43) Pub. Date: Jan. 17, 2013

(54) THIN-FILM SPEAKER SYSTEM AND METHODS FOR MAKING AND USING THE SAME

(71) Applicants: Randall Boudouris, Sylvania, OH (US); Mike Orra, Maumee, OH (US); Joseph Patrick Moening, Sault Ste. Marie, MI (US); Steven Papadimos, Toledo, OH (US)

(72) Inventors: Randall Boudouris, Sylvania, OH (US); Mike Orra, Maumee, OH (US); Joseph Patrick Moening, Sault Ste. Marie, MI (US); Steven Papadimos, Toledo, OH (US)

(21) Appl. No.: 13/492,043

(22) Filed: Jun. 8, 2012

Related U.S. Application Data
(60) Provisional application No. 61/495,609, filed on Jun. 10, 2011.

(51) Int. Cl. H04R 17/00; H04R 31/00

(52) U.S. Cl. 381/190; 29/594

(57) ABSTRACT

A speaker system comprising a power source, an audio processor, a speaker comprising at least one conductive component comprising conductive ink, an enabling device, wherein the enabling device provides power to the audio processor, memory and speaker, and a memory, wherein the memory contains audio data, wherein the speaker has substantially uniform thickness and thickness substantially similar to that of paper, wherein the speaker is capable of being inserted seamlessly into written materials, and wherein electricity is transmitted using conductive components and the conductive components comprise a conductive ink and wherein electricity coming from the enabling device, when applied to the speaker, causes mechanical deformation and sound.

### CROSS-REFERENCE TO RELATED APPLICATIONS

This application claims priority to U.S. Provisional Patent Application No. 61/495,609 filed Jun. 10, 2011, the entire contents of which are hereby incorporated herein by reference.

### BACKGROUND OF THE INVENTION

The present invention relates to speaker systems and methods of making and using the same.

Piezoelectricity is the charge which accumulates in certain solid materials in response to applied mechanical strain. Piezoelectricity may result from the piezoelectric effect.

The piezoelectric effect refers to the ability of some materials to change their static dimension when an external electric field is applied to the material.

The piezoelectric effect is understood as the linear electromechanical interaction between the mechanical and the electrical state in crystalline materials with no inversion symmetry. The piezoelectric effect is a reversible process in that materials exhibiting the direct piezoelectric effect (the internal generation of electrical charge resulting from an applied mechanical force) also exhibit the reverse piezoelectric effect (the internal generation of a mechanical force resulting from an applied electrical field).

Piezoelectricity is useful in applications such as the production and detection of sound, generation of high voltages, electronic frequency generation, microbalances, and ultra fine focusing of optical assemblies. It is also the basis of a number of scientific instrumental techniques with atomic resolution, the scanning probe microscopes such as STM, AFM, MTA, SNOM, etc., and everyday uses such as acting as the ignition source for cigarette lighters and push-start propane barbecues.

Polyvinylidene fluoride (PVDF) is one material known for its piezoelectric capabilities. The principal crystal-line forms of PVDF are the highly polar β form and the non-polar α form. By carefully controlling process steps to polarize a film, a highly piezoelectric film results. This is also shown in “Processing, Structure and Properties of PVDF Films” and “α-to-β Transformation on PVDF Films Obtained by Uniaxial Stretch,” which are hereby incorporated by reference. Once polarized, the PVDF may be ideal for many piezoelectric applications.

The piezoelectric effect has been used in a variety of applications including loudspeakers. The usage for audio production, however, in general has been limited, as achieving the dynamic range necessary for high fidelity applications is difficult.

It would be advantageous to have a speaker system that is thin and of uniform thickness that could be employed for use in combination with written materials.

### SUMMARY OF THE INVENTION

In one aspect, the present invention relates to a speaker system including a power source, an audio processor, a speaker comprising at least one conductive component comprising conductive ink, an enabling device, wherein the enabling device provides power to the audio processor, memory and speaker, a memory, wherein the memory contains audio data, wherein the speaker has substantially uniform thickness and thickness substantially similar to that of paper, wherein the speaker is capable of being inserted seamlessly into written materials, and wherein electricity is transmitted using conductive components and the conductive components comprise a conductive ink and wherein electricity coming from the enabling device, when applied to the speaker, causes mechanical deformation and sound.

In another aspect, the present invention relates to a publication method including the steps of connecting a power source to an audio processor; connecting a speaker to the audio processor to form a speaker device, connecting an enable to the power source, wherein the enable controls the flow of electricity, connecting a memory to the audio processor, wherein the memory contains audio data, adding conductive material to a thin substrate using a thin-film deposition technique, wherein the thin substrate with conductive material thereon has a substantially uniform thickness substantially similar to that of paper, and wherein electricity coming from the power source, when applied to the substrate, causes mechanical deformation and in turn, sound, and wherein the thin substrate is a speaker device and may be seamlessly inserted into written material.

These and other aspects, embodiments and advantages of the present disclosure will become immediately apparent to those of ordinary skill in the art upon review of the Detailed Description and Claims to follow.

### BRIEF DESCRIPTION OF THE DRAWINGS

FIG. 1 schematically shows three main components of the speaker system as an aspect of this invention.

FIG. 2 schematically shows the main components of the speaker system produced by a discrete process within printed materials as an aspect of the prevent invention.

FIG. 2A schematically shows the main components within the printed materials with the hanger closed as an aspect of this invention.

FIG. 3 schematically shows the speaker system with additional illustrated components as an aspect of the prevent invention.

FIG. 4 schematically shows a detailed schematic of the speaker system formed by a discrete process as an aspect of the prevent invention.

FIG. 5 schematically shows a battery that can be implemented in an integrated print process as an aspect of the present invention.

FIG. 6 schematically shows a solar cell that can be implemented in an integrated print process as an aspect of the prevent invention.

FIG. 7 schematically shows a capacitor that can be implemented in an integrated print process as an aspect of the prevent invention.

### DETAILED DESCRIPTION OF THE INVENTION

While embodiments of the present invention may take many forms, there are described in detail herein, specific embodiments of the present disclosure. This description is an exemplification of the principles of the present disclosure and is not intended to limit the disclosure to the particular embodiments illustrated herein.

In one aspect, the present invention relates to a speaker system including a power source, audio processor, and speaker device. The speaker device may include a thin, paper-like substrate, with a battery and piezoelectric thin film (e.g., polyvinylidene fluoride) formed and/or deposited thereon. The components of the paper-thin speaker system may be deposited on a substrate using thin film deposition techniques in an integrated process, or may be discretely formed on the substrate.

In one embodiment, the present invention relates to a speaker system including a power source, an audio processor, a speaker device, an enabling device, and/or a memory.

In some embodiments, the enabling device controls “power” from the battery to the entire electronic system, e.g., audio processor, memory, speaker, etc. In further examples, the memory may contain audio data.

In some embodiments, the speaker device may have a substantially uniform thickness and/or thickness substantially similar to that of paper allowing the speaker device to be inserted seamlessly into printed materials. Electricity is transmitted using conductive components and the conductive components comprise a conductive ink.

In another aspect, the present invention relates to a method of producing a thin-film speaker system that may be used in printed materials such as cards, magazines, advertisements, billboards, books, and the like.

In some embodiments, the present invention relates to a paper thin speaker system that is capable of being used in written materials such as books, magazines, advertisements, and the like.

As discussed in the Background of the Invention, the piezoelectric effect is understood as the linear electromechanical interaction between the mechanical and the electrical state in crystalline materials with no inversion symmetry. The piezoelectric effect is a reversible process in that materials exhibiting the direct piezoelectric effect (the internal generation of electrical charge resulting from an applied mechanical force) also exhibit the reverse piezoelectric effect (the internal generation of a mechanical force resulting from an applied electrical field).

Piezoelectricity is the charge which accumulates in certain solid materials in response to applied mechanical strain. Piezoelectricity may result from the piezoelectric effect.

Therefore, it will be appreciated that in some embodiments, it may be desirable to apply the piezoelectric effect to high fidelity applications while achieving the requisite dynamic range.

In some embodiments, the piezoelectric effect is operates “in reverse”. That is, the electricity coming from the output drive stage of the circuitry, when applied to the PVDF film causes mechanical deformation and in turn, sound.

In another aspect, the present invention relates to a method of making an electronic system including the steps of connecting a power source to an audio processor, connecting a speaker to the audio processor to form a speaker device, connecting an enabling device to the power source, wherein the enabling device controls power to the to the audio processor/electronic system, connecting a memory to the audio processor, wherein the memory contains audio data, and adding conductive material to a substrate using a thin-film deposition technique.

The resultant speaker system has substantially uniform thickness and thickness substantially similar to that of paper and can be inserted seamlessly into written material, wherein electricity coming from the output drive stage of the circuitry, when applied to the substrate causes mechanical deformation and in turn, sound.

In some cases, the substrate may be paper-like (e.g., of or including paper, and/or a flexible, thin substrate that is capable of being printed on, and the like).

In some embodiments, the present invention relates to a thin-film (e.g., paper-thin) speaker system capable of being printed on a thin substrate (e.g., paper or a paper-like material) in order to produce a paper-like sheet and/or article that is able to play audible sounds.

In a specific embodiment, polyvinylidene fluoride (PVDF) and/or other similar materials are stretched uniaxially to a particular draw ratio under certain temperature and pressure conditions. The mechanical deformation of the material can result in its exhibition of piezo effect, which may produce sound.

A metallic coating can then be applied on one or both sides of the film via deposition, conductive inks, and/or the like to provide terminals through which a current can be passed. Through this integrated print process, words, pictures, and/or the like may be printed directly on the materials such that a paper-like sheet and/or article with an integrated battery and/or power source, that is capable of playing audio sounds, is produced.

Thus, an electrode (e.g., a thin conductive layer) may be printed on a material such as PVDF and the like by an integrated printing process.

The resultant paper-thin speaker systems may comprise discrete components, in which each of the speakers, electrode and/or battery, and other components are layered onto a PVDF sheet or the like in order to form the paper thin speaker system.

In some embodiments, thin film batteries may be able to be formed in substantially any shape and size. See U.S. Publication No. 2008/0001577, the entire content of which is incorporated by reference herein in its entirety.

In some embodiments, flexible batteries may be made by printing onto pliable material, such as paper. The same basic production principles may be leveraged to produce a battery that serves the power demands of a piezoelectric speaker system, in certain exemplary instances.

Desirably, the speaker system is thin and of uniform thickness. It may also be desirable to construct a speaker system using a commercially efficient thin-film deposition technique which can be employed in combination with written material.

In some embodiments, the present invention relates to a method of producing a thin-film speaker system that may be used in printed materials such as cards, magazines, advertisements, billboards, books, and the like.

In some embodiments, a speaker system is constructed using commercially efficient thin-film deposition techniques which can further be used in combination with written materials.

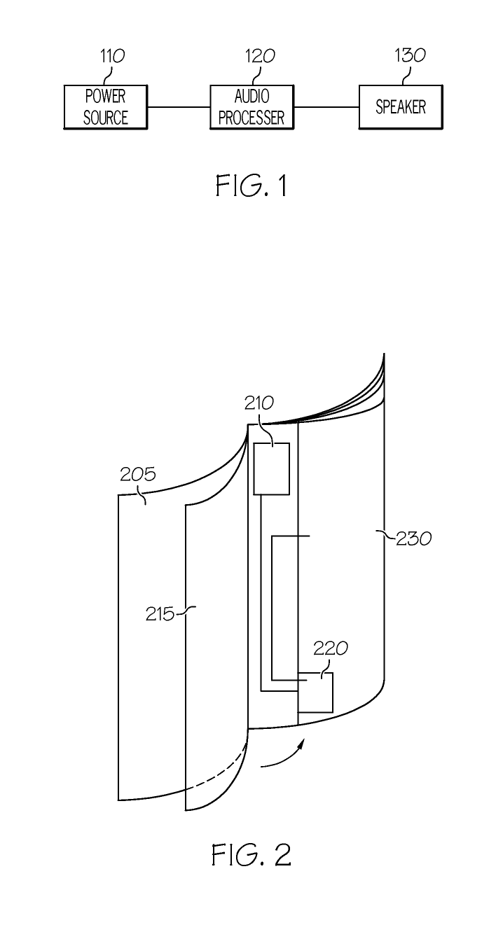

The embodiment of FIG. 1 shows a simplified schematic of the speaker system 1. The system contains three main components: the power source 110, the audio processor 120 and the speaker 130. The power source 110 for this system could take the form of a printable battery, capacitor, a solar cell or any other power source. To obtain the necessary voltage, current and power requirements to operate this device, multiple cells (battery, capacitor or solar) may need to be connected in series and/or parallel.

The power source 110 delivers power to an audio processor 120. The audio processor 120 converts recorded audio data into an audio signal. The audio signal amplified and sent to the speaker 130 where it is further converted into audible waves. The speaker 130 is similarly powered by the power source 110 and may include any type of speaker including, but not limited to, a piezoelectric speaker.

Speaker 130 may comprise a substrate that is of, or includes, paper, or speaker 130 may comprise a thin, flexible substrate, that is some cases is capable of being printed on (e.g., paper, cardboard, thin plastics, glass, and other types of suitable thin-film substrates, etc.).

This list is intended for illustrative purposes only, and not as a limitation on the scope of the present invention.

System 1 may be created through at least two different processes: a discrete process and an integrated process. In a discrete process, individually produced parts may be combined to create a functioning speaker system. In an integrated process, each element of the system may be printed onto a substrate (e.g., a PVDF film, other type of thin-film, paper, or other suitable substrate) through a deposition chamber (e.g., via physical vapor deposition; sputter deposition chamber; etc.) and then the resulting printed and/or coated article may be used as a paper-thin, functional speaker system.

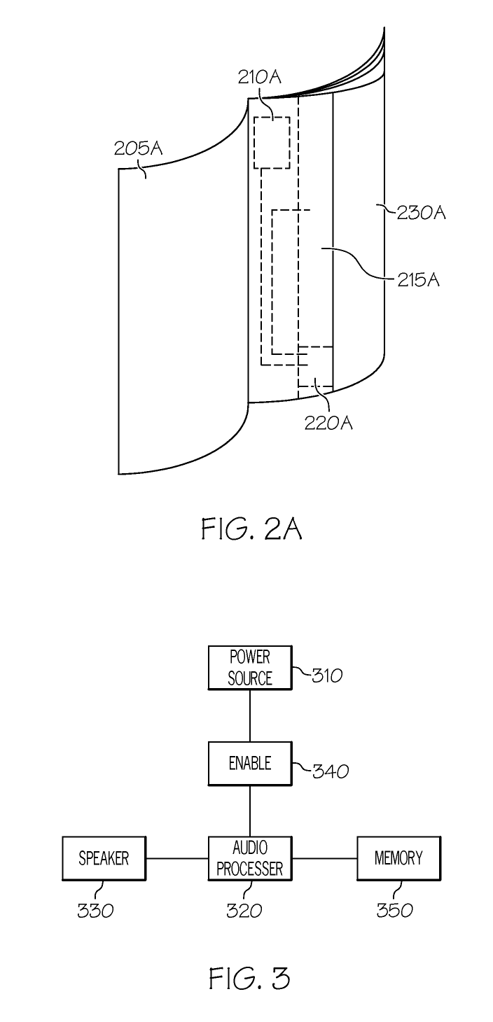

FIG. 2 shows a speaker system 2 comprising a power source 210, an audio processor 220, and a speaker 230. The power source 210 may be a thin-film battery and the speaker 230 may be a paper thin piezoelectric speaker. Speaker system 2 may further be oriented in at least one direction and coated with a conductive material that gives it piezo qualities, for example, PVDF or the like.

System 1 and/or 2 may be placed seamlessly inside of a printed material 205. The printed material 205 may be any form of paper or paper-thin material and may contain any type of information, including articles and advertisements. The written material 205 may be a card and/or a billboard, or the like. The written material 205 may be in essentially any form, such as magazines, direct mail pieces, newspapers, and the like. An audio signal generated by the speaker 230 may supplement the information on the written material 205 with voice, music, etc. to help engage the reader in the written material 205. A discrete process may also be completed in die-form so as to assume a low-profile footprint. Once in die form, the system would be thin enough to be seamlessly inserted into printed materials. Desirably, to be inserted seamlessly, the system 1 and/or 2 should have a substantially similar size and pliability as compared to the written materials.

The speaker system(s) 1 and/or 2 within the written material may also include a hanger 215 to help hide the components from view. FIG. 2 shows the hanger 215 in a leftward position, exposing many components of the system including the power source 210, the audio processor 220 and the speaker 230.

The hanger is optional and may not be included and/or may be positioned differently.

In FIG. 2A, the hanger has been moved along the arrow illustrated of FIG. 2. Once moved, many components of the speaker system become obscured. As illustrated, the written material 205A comprises a hanger in the rightward position. As such, the power source 210A, the audio processor 220A, and a portion of the speaker 230A are hidden from view. The words “rightward” and “leftward” are not to be limiting, but are used for convenience to designate directions in the drawings to which references is made.

FIG. 3 illustrates an alternative embodiment of the invention. FIG. 3 shows a more detailed schematic of the speaker system 1 and/or 2 with additional components. In addition to the power source 310, the audio processor 320 and the speaker 330, the speaker system contains an enable 340 and a memory 350.

The enable 340 in FIG. 3 may be driven by a phototransistor switch so that the speaker system operates only when exposed to a light source. When no light source is present, the speaker system remains is a sleep mode to conserve power. This feature may be advantageous when the system is placed in printed materials 205 with multiple pages. When a page containing the speaker system is opened, the light will drive the phototransistor of the enable 340 and ultimately generate the sound used to supplement the information on the page within the written material 205.

The speaker system may also be enabled by other events in addition to exposure to light. The governing switch/sensor could be implemented using, for example, but not limited to, a phototransistor, photodiode, magnetic sensor, temperature sensor, pressure sensor, and/or a microphone or the like. The memory may be any form of memory and contain audio data in any format including, but not limited to, a WAV format.

The speaker 330 may work in conjunction with other output devices. For example, the user output may include visual components such as light-emitting diodes or micro-electro-mechanical systems. These components would be similarly powered by the power source 310.

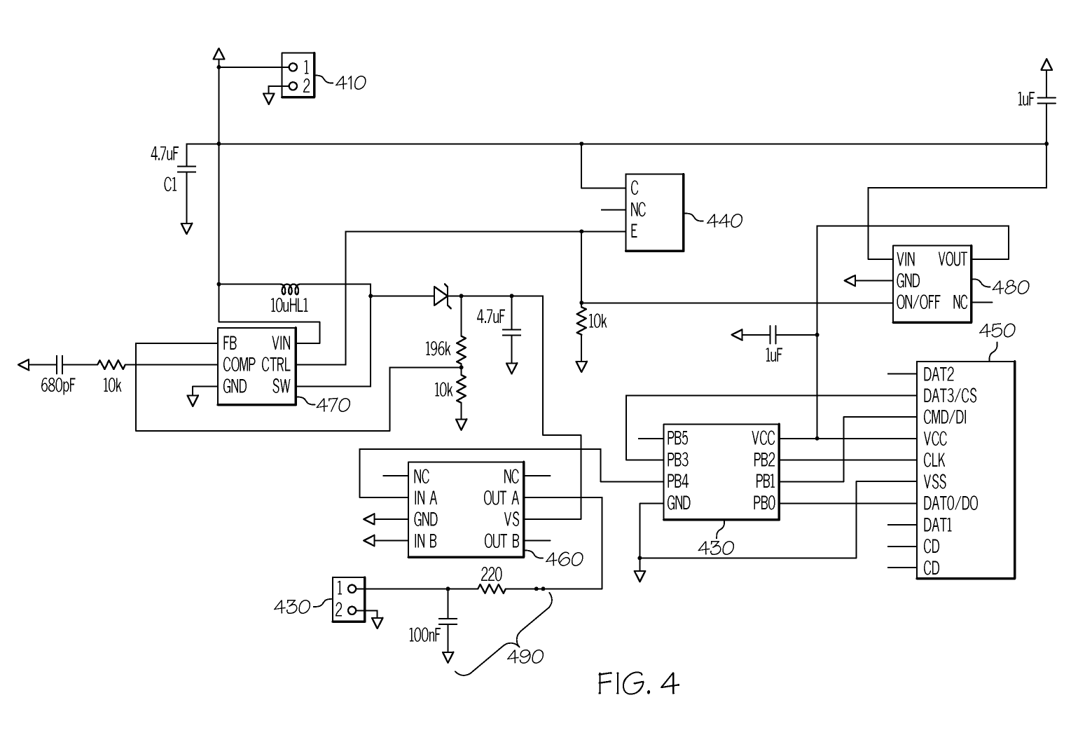

FIG. 4 shows a specific embodiment of the speaker system using a discrete process. The power source 410 is represented by an input port. The power source 410 is used to generate electricity to the speaker system. As illustrated, it is connected directly to the VIN port of the voltage regulator 470, the enable 440, and the voltage regulator 480. The voltage regulator 470 may be Texas Instruments part TPS61170 and have an operating voltage of 3.6v-4.2v.

To drive the thin-film speaker 430, the voltage regulator 470 may produce a 24V output to supply power to gate driver 460 which takes the input low-power audio signal and produces an output waveform with a peak voltage of 24V that is capable of driving the capacitive thin-film speaker load. The gate driver 460 may be an IXYS part IXDN404. The output from the gate driver 460 is passed through a simple low-pass filter 490 to reduce output stage power requirements. Finally, the output of the low-pass filter is passed to the thin-film speaker 430 represented as an output port.

The enable 440 may be a phototransistor such as Siemens part SFH3400 and may be in an on mode or an off mode. It functions as a switch so that the speaker system can operate only when exposed to a light source. Otherwise, it is in a sleep mode to conserve power. The enable 440 is further connected to the ON/OFF port of a voltage regulator 480 in order to control the flow of electricity to the audio processor 430 and memory 450.

As such, when the enable is in an on mode, it allows the voltage regulator 480 to drive electricity to the audio processor 430 and memory 450 causing the system to generate sound. When the enable is in an off mode, the electricity does not flow to the audio processor 430 or memory 450 and the system emits no sound. The regulator 480 may be an Analog Devices part ADP121.

When the enable 440 is in an on mode, a 3.3v power source is output from the VOUT port of the regulator 480 into the VCC inputs of the audio processor 430 and the memory 450. The audio processor may be an Atmel ATTINY85 microcontroller and the memory may be a MicroSD flash memory. The audio processor port PB0 is connected to the memory output port DAT0/D0 so that it may read the digitized audio stored in a data format such as WAV to generate an audio signal using fast pulse-width modulation with a 250 kHz carrier.

The audio signal is output from port PB4 of the audio processor. With the components in the FIG. 4, the audio signal is insufficient to drive the thin film speaker 430 directly. Therefore, it uses the gate driver460 to amplify the signal.

The speaker system can also be implemented through an integrated process. The integrated process has certain advantages over a discrete process. For example, it will result in a paper-thin system with uniform thickness. Also, it may reduce the cost of manufacturing the system in large quantities.

An integrated print process is one method of forming the speaker system by an integration process. It is simply a method of forming each of the desired components using various printing or other thin film deposition techniques including but not limited to deposition via inkjet, laser, embossed, and/or other deposition methods, including but not limited to chemical vapor deposition (CVD), combustion chemical vapor deposition (CCVD), sputtering, plasma, ion beam deposition, ion beam assisted deposition (IBAD), and/or the like.

In some embodiments, the present invention utilizes an integrated print process, the electronic portion of the device may be printed rather than assembled from discrete components. This may be achieved through the use of inks or coatings that are filled with conductive materials such as silver, copper, carbon nanotubes or any other conductive material in certain instances. Printing can be achieved through the use of, for example, traditional offset printing, rotary screen, flexography, gravure, knife over roll coating, extrusion coating, and tower solvent based coating. The ability to print the integrated electronics portion of this device represents a significant leap in the productivity and thus the cost to manufacture the device is greatly reduced.

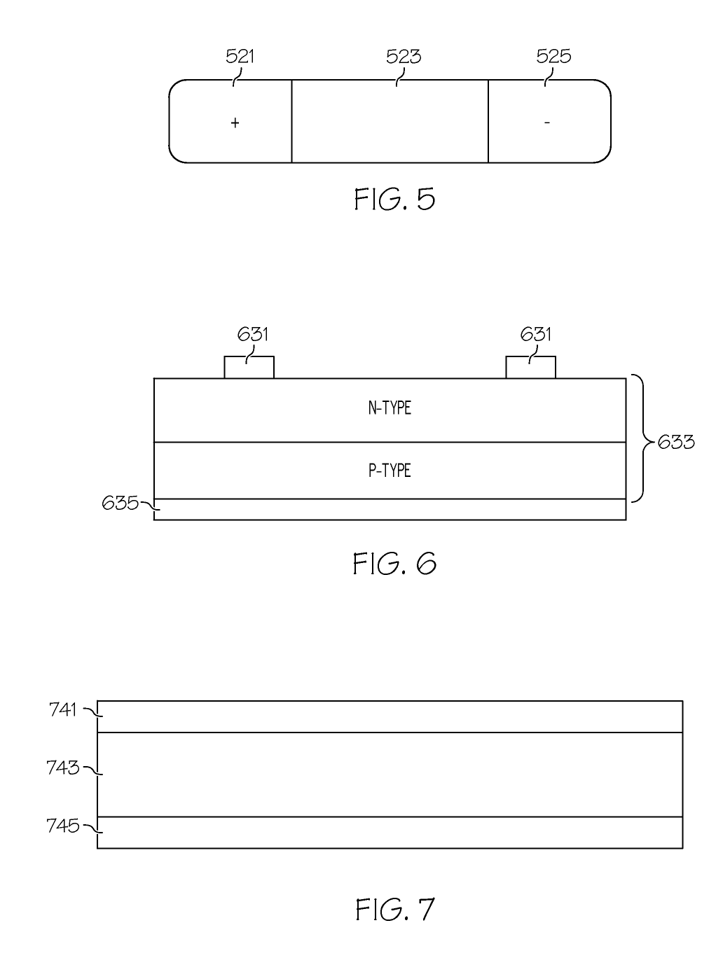

The printable battery may be any type of electrochemical storage device that can be fabricated using a series of printing (offset, screen, inkjet, etc.) or other thin-film deposition techniques (chemical vapor deposition, evaporation, sputtering, etc.). As shown in the embodiment of FIG. 5, these devices comprise three main components: an anode 525, electrolyte 523 and cathode 521. Such devices could be fabricated from a wide variety of battery technologies including; lithium-polymer, zinc-air, zinc-manganese, nickel metal hydride, silver-zinc, zinc-carbon, etc.

In some embodiments, a printable solar cell can be any type of photovoltaic based device that can be fabricated using a series of printing (offset, screen, inkjet, etc.) or other thin film deposition (chemical vapor deposition, evaporation, sputtering, etc.) techniques. As shown in the embodiment of FIG. 6, these devices comprise three main components: a bottom contact 635, a light sensitive junction 633 (shown as a p-n junction) and a top electrode 631. Such devices can be fabricated using various technologies including; amorphous silicon, copper indium gallium selenide, organic technologies, etc.

In some embodiments, a printable capacitor is any type of electrostatic or electrochemical capacitor based storage device that can be fabricated using a series of printing (offset, screen, inkjet, etc.) or other thin film deposition (chemical vapor deposition, evaporation, sputtering, etc.) techniques. As shown in the embodiment of FIG. 7, these devices comprise three main components: a first electrode 741, a second electrode 745 and a dielectric material 743. Such devices can be fabricated using various technologies including simple devices using conductive materials separated by an insulator or advanced designs using activated charcoal, graphene, carbon nano tubes, etc.

In some embodiments, the integrated print process may advantageously result in a cost-effective way to place a speaker system inside of written materials. Once created, the value of the devices comes from its thinness and uniform thickness. Due to these characteristics, the speaker system can be seamlessly inserted into magazines, direct mail pieces and newspapers. This advantage results in a significant reduction in the overall cost of sound generating advertisement.

In this application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

The description provided herein is not to be limited in scope by the specific embodiments described which are intended as single illustrations of individual aspects of certain embodiments. The methods, compositions and devices described herein can comprise any feature described herein either alone or in combination with any other feature(s) described herein. Indeed, various modifications, in addition to those shown and described herein, will become apparent to those skilled in the art from the foregoing description and accompanying drawings using no more than routine experimentation. Such modifications and equivalents are intended to fall within the scope of the appended claims.

All publications, patents and patent applications mentioned in this specification are herein incorporated by reference in their entirety into the specification to the same extent as if each individual publication, patent or patent application was specifically and individually indicated to be incorporated herein by reference. Citation or discussion of a reference herein shall not be construed as an admission that such is prior art.

1. A speaker system comprising:
a power source;
an audio processor;
a speaker comprising at least one conductive component comprising conductive ink;
an enabling device, wherein the enabling device provides power to the audio processor, memory and speaker;
a memory, wherein the memory contains audio data;
wherein the speaker has substantially uniform thickness and thickness substantially similar to that of paper, wherein the speaker is capable of being inserted seamlessly into written materials, and wherein electricity is transmitted using conductive components and the conductive components comprise a conductive ink; and
wherein electricity coming from the enabling device, when applied to the speaker, causes mechanical deformation and sound.

2. The speaker system of claim 1, wherein the enabling device is a photovoltaic.

3. The speaker system of claim 1, wherein the enabling device is triggered by a pressure sensor.

4. The speaker system of claim 1, further comprising a light-emitting diode, wherein the light emitting diode is powered by the enabling device.

5. The speaker system of claim 1, wherein the speaker system is in sleep mode when not driven by the enabling device.

6. The speaker system of claim 1, wherein the speaker system is made using an integrated print process.

7. The speaker system of claim 1, wherein the speaker comprises polyvinylidene fluoride processed to exhibit piezo characteristics.

8. The speaker system of claim 1, further comprising written materials into which the speaker device is inserted

9. The speaker system of claim 8, wherein the written materials comprise a hanger positioned to obscure portions of the speaker system from view.

10. A method for assembly a speaker system for use in combination with written material:
connecting a power source to an audio processor; connecting a speaker to the audio processor to form a speaker device;
connecting an enable to the power source, wherein the enable controls the flow of electricity;
connecting a memory to the audio processor, wherein the memory contains audio data;
adding conductive material to a thin substrate using a thin-film deposition technique;
wherein the thin substrate with conductive material thereon has a substantially uniform thickness substantially similar to that of paper, and wherein electricity coming from the power source, when applied to the substrate, causes mechanical deformation and in turn, sound, and wherein the thin substrate is a speaker device and may be seamlessly inserted into written material.

11. The publication method of claim 10, wherein the enable is a photovoltaic.

12. The publication method of claim 10, wherein the enable comprises a pressure sensor.

13. The speaker system of claim 1, wherein the speaker system is in sleep mode when not driven by the enable.

14. The publication method of claim 10, further comprising connecting a light-emitting diode to the audio processor.

15. The publication method of claim 10, wherein the thin-film deposition process includes using a printer to print conductive ink.

16. The publication method of claim 10, wherein the power source is a battery that is formed using a thin-film deposition technique.

17. The publication method of claim 10, wherein the power source is a solar cell that is formed using a thin-film deposition technique.

18. The publication method of claim 10, wherein the power source is a capacitor that is formed using a thin-film deposition technique

19. The publication method of claim 10, wherein the thin-film deposition process includes a chemical deposition technique.

20. The publication method of claim 10, wherein the speaker plays audio used to supplement advertisements in the written materials.
